(19) United States
(12) Patent Application Publication
(10) Pub. No.: US 2015/0298310 A1
(43) Pub. Date: Oct. 22, 2015

(54) SNAP RING PLIERS WITH REMOVABLE AND ADJUSTABLE TIPPED PARTS

(71) Applicant: John A. Cronin, Queen Creek, AZ (US)

(72) Inventor: John A. Cronin, Queen Creek, AZ (US)

(21) Appl. No.: 14/257,780

(22) Filed: Apr. 21, 2014

(51) Int. Cl. B25F 1/00; B23D 71/04; B25B 27/20

(52) U.S. Cl. CPC B25F 1/003; B25B 27/205; B23D 71/04

(57) ABSTRACT

Snap ring pliers include pivotally attached first section and second sections having first and second respective jaw portions, a first tipped part having a first minor tip and a first major tip, and a second tipped part having a second minor tip and a second major tip. A pivot pivotally couples the first section to the second section for movement of the first and second jaw portions between closed and open positions. The first and second tipped parts are removably connectable to the respective first and second jaw portions in first orientations for forming a minor snap ring gap tongue by the first and second minor tips in the closed position of the first and second jaw portions, and for forming a comparatively larger major snap ring gap tongue by the first and second major tips in the closed position of the first and second jaw portions.

### FIELD OF THE INVENTION

The present invention relates to impact wrenches and, more particularly, to a tool for installing and removing snap rings relative to an impact wrench.

### BACKGROUND OF THE INVENTION

An impact wrench is a socket wrench power tool designed to deliver high torque output with minimal exertion by the user by storing energy in a rotating mass or hammer that is delivered suddenly to an output shaft or anvil. A socket is attached to the anvil, and the rotating hammer is accelerated by a motor and then suddenly connected to the anvil creating a high torque impact to the anvil and, in turn, to the socket attached to the anvil. The hammer mechanism is designed such that after delivering the impact the hammer is again allowed to spin freely. With this design, the only reaction force applied to the body of the tool is the motor accelerating the hammer, and thus the operator feels very little torque, even though a very high peak torque is delivered to the socket. Compressed air is the most common power source for impact wrenches, although electric and hydraulic power is also used, with cordless electric impact wrenches becoming more popular.

Various attachment systems are used to attach sockets to the anvils of impact wrenches. Common attachment systems include a spring-loaded pin incorporated in the anvil that snaps into a corresponding hole formed in the socket, or a snap ring which holds the socket by friction or by snapping into indents machined into the socket. A typical snap ring is a severed ring formed of rugged spring steel, which encircles an O-ring located in an annular groove formed in the anvil. A snap ring must be periodically replaced due to damage and wear. Installing and removing a snap ring relative to an anvil is difficult and somewhat time consuming, especially differently sized snap rings. Accordingly, there is a specific need in the art for a specialized tool that is adjustable for installing and removing snap rings of varying sizes relative to anvils of impact wrenches.

### SUMMARY OF THE INVENTION

According to the principle of the invention, snap ring pliers includes a first section includes a first handle portion and an opposed first jaw portion, a second section includes a second handle portion and an opposed second jaw portion, a first tipped part includes a first minor tip and an opposed first major tip, and a second tipped part includes a second minor tip and an opposed second major tip. The first and second tipped parts are removably connectable to the respective first and second jaw portions in first orientations operatively relating the first and second minor tips of the first and second tipped parts outwardly from the first and second jaw portions, and second orientations operatively relating the first and second major tips of the first and second tipped parts outwardly from the first and second jaw portions. A pivot pivotally couples the first section to the second section for movement between a first position of the first and second sections and a second position of the first and second sections. The first position of the first and second sections is a closed position of the first and second jaw portions and an open position of the first and second handle portions. The second position of the first and second sections is an open position of the first and second jaw portions and a closed position of the first and second handle portions. In the first orientations of the first and second tipped parts the first and second minor tips mate in the closed position of the first and second jaw portions to form a minor tongue adapted to be received in a snap ring gap, and the first and second minor tips are spaced apart and separated by a gap in the open position of the first and second jaw portions. In the second orientations of the first and second tipped parts the first and second major tips mate in the closed position of the first and second jaw portions to form a major tongue adapted to be received in a snap ring gap, and the first and second major tips are spaced apart and separated by a gap in the open position of the first and second jaw portions. The minor tongue is smaller than the major tongue. A bias acts on the first and second sections biasing the first and second sections in the first position. The bias is supplied by a spring coupled between the first and second sections. There is a first engagement assembly for removably connecting the first tipped part to the first jaw portion in each of the first and second orientations of the first tipped part, and a second engagement assembly for detachably connecting the second tipped part to the second jaw portion in each of the first and second orientations of the second tipped part.

The first engagement assembly includes a first detent assembly for alternately keeping the first tipped part in the first orientation and the second orientation relative to the first jaw portion, and a first fastener for alternately releasably fastening the first tipped part to the first jaw portion in the first orientation and the second orientation of the first tipped part relative to the first jaw portion. The first detent assembly includes first detent elements carried by the first jaw portion and first complementing detent elements carried by the first tipped part. Each of the first detent elements is one of a first male detent element and a first female detent element, and each of the first complementing detent elements is the other of the first male detent element and the first female detent element. The first fastener is a first threaded fastener.

The second engagement assembly includes a second detent assembly for alternately keeping the second tipped part in the first orientation and the second orientation relative to the second jaw portion, and a second fastener for alternately releasably fastening the second tipped part to the second jaw portion in the first orientation and the second orientation of the second tipped part relative to the second jaw portion. The second detent assembly includes second detent elements carried by the second jaw portion and second complementing detent elements carried by the second tipped part. Each of the second detent elements is one of a second male detent element and a second female detent element, and each of the second complementing detent elements is the other of the second male detent element and the second female detent element. The second fastener comprises a second threaded fastener.

A file is removably connected to the second section between the second handle portion and the second jaw portion. The file projects outboard of the second section. A third engagement assembly removably connects the file to the second section. The third engagement assembly includes a third detent assembly temporarily keeping the file in position on the second section, and a third fastener releasably fastening the file to the second section. The third detent assembly includes third detent elements carried by the second section and third complementing detent elements carried by the file. Each of the third detent elements is one of a third male detent element and a third female detent element, and each of the third complementing detent elements is the other of the third male detent element and the third female detent element. The third fastener comprises a third threaded fastener.

The first tipped part and the second tipped part are identical. The first engagement assembly, the second engagement assembly, and the third engagement assembly are identical.

### BRIEF DESCRIPTION OF THE DRAWINGS

Referring to the drawings:

FIG. 1 is a perspective view of snap ring pliers constructed and arranged in accordance with the principle of the invention, the snap ring pliers including a first section having a first handle portion and an opposed first jaw portion, a second section having a second handle portion and an opposed second jaw portion, a file removably connected to the second section, a first tipped part, having a first minor tip and an opposed first major tip, removably connected to the first jaw portion, and a second tipped part, having a second minor tip and an opposed second major tip, removably connected to the second jaw portion, the snap ring pliers being shown in a closed position mating first and second minor tips of the first and second tipped parts in preparation for use of the snap ring pliers for snap ring installation and removal purposes;

FIG. 2 is a top plan view of the embodiment of FIG. 1 illustrating the first and second minor tips of the first and second tipped parts of the snap ring pliers inserted in a snap ring gap between snap ring ends of a snap ring depicted in phantom outline;

FIG. 3 is a bottom plan view of the embodiment of FIG. 1;

FIG. 4 is a section view taken along line 4-4 of FIG. 2;

FIG. 5 is a section view taken along line 5-5 of FIG. 2;

FIG. 6 is an enlarged fragmented view of the embodiment of FIG. 2 illustrating the first and second minor tips of the first and second tipped parts of the snap ring pliers inserted in the snap ring gap between snap ring ends of the snap ring depicted in phantom outline;

FIG. 7 is an enlarged, fragmented perspective view of the snap ring pliers of FIG. 6 showing the snap ring pliers in the closed position mating the first and second minor tips of the first and second tipped parts;

FIG. 8 is a view similar to that of FIG. 2 illustrating the snap ring pliers in an open position spreading apart the first and second minor tips of the first and second tipped parts opening the snap ring for snap ring removal and installation purposes;

FIG. 9 is an enlarged fragmented perspective view of the embodiment of the snap ring pliers of FIG. 8;

FIG. 10 is a partially exploded perspective view of the embodiment of the snap ring pliers of FIG. 9 illustrating the first and second tipped parts detached from the respective first and second jaw portions, and illustrating the file detached from the second section;

FIG. 11 is a view similar to that of FIG. 10 illustrating the file removably connected to the second section, and illustrating the first and second tipped parts detached from the respective first and second jaw portions and reoriented relating the first major tip of the first tipped part with the second major tip of the second tipped part;

FIG. 12 is a view similar to that of FIG. 11 illustrating the first and second tipped parts removably connected to the respective first and second jaw portions and reoriented relating the first major tip of the first tipped part with the second major tip of the second tipped part, the snap ring pliers being shown in a closed position mating first and second major tips of the first and second tipped parts in preparation for use of the snap ring pliers for snap ring installation and removal purposes; and

FIG. 13 is a top plan view of the embodiment of FIG. 12 illustrating the first and second major tips of the first and second tipped parts of the snap ring pliers inserted in a snap ring gap between snap ring ends of a snap ring depicted in phantom outline.

### DETAILED DESCRIPTION OF THE PREFERRED EMBODIMENT

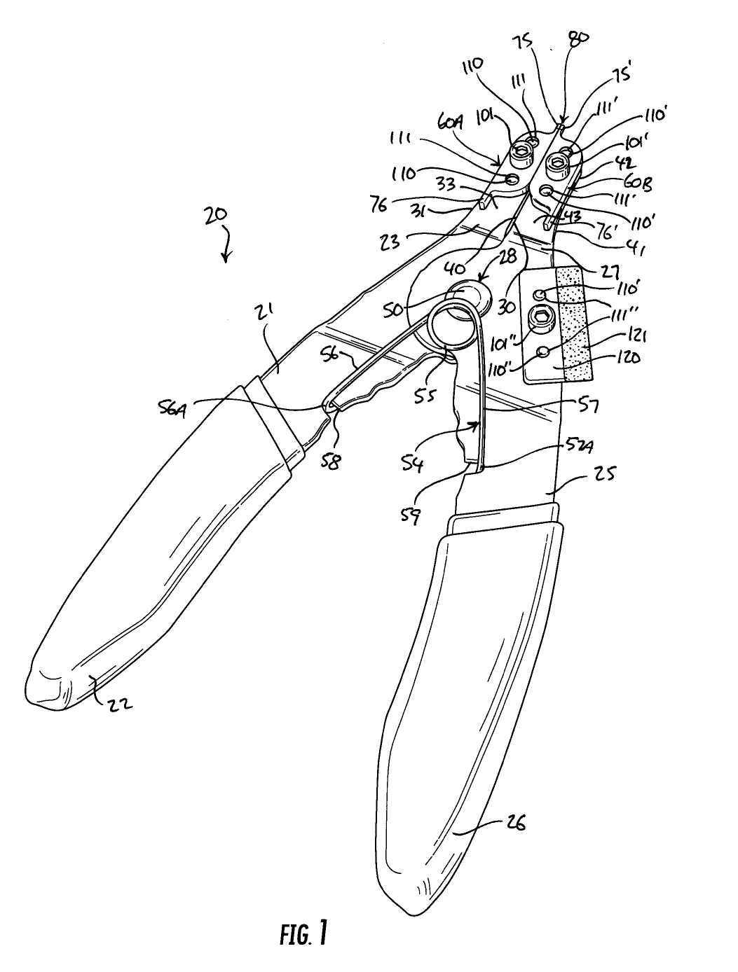

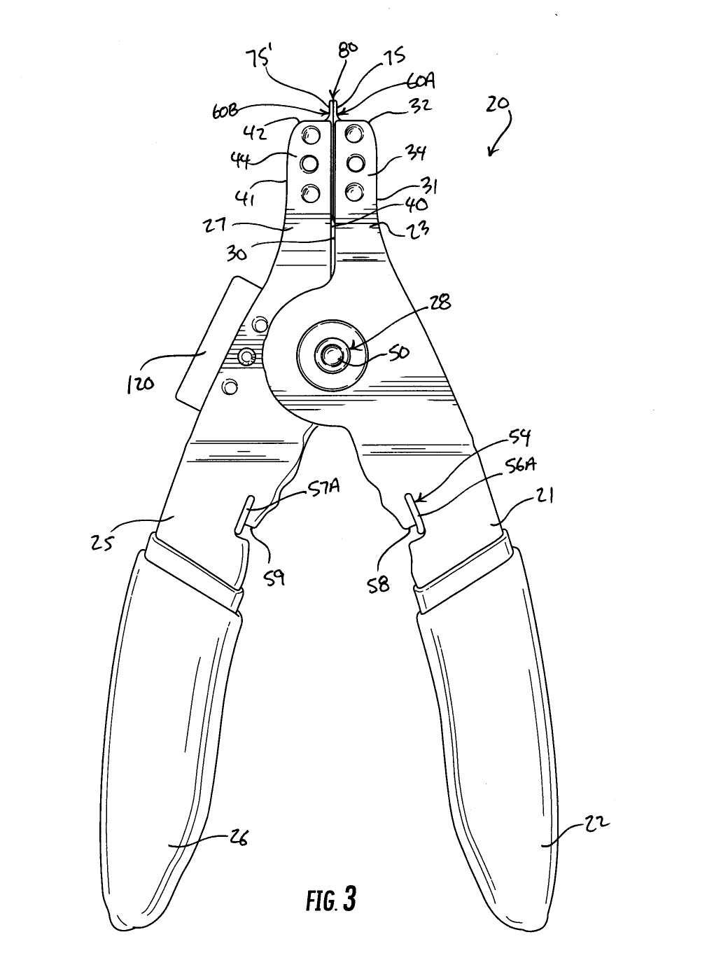

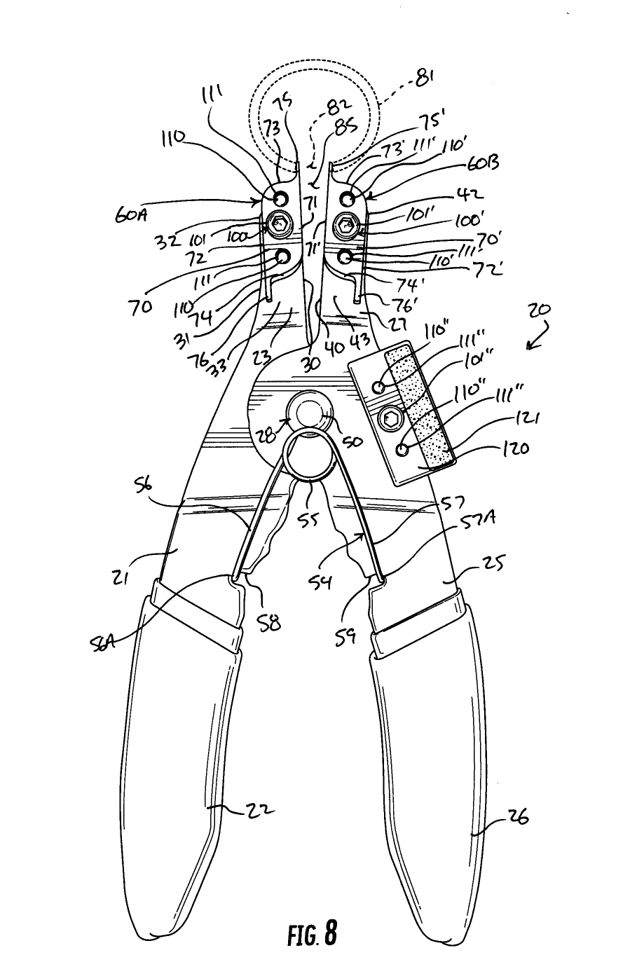

Turning now to the drawings, in which like reference characters indicate corresponding elements throughout the several views, attention is first directed in relevant part to FIGS. 1-3, and FIGS. 6-13 in which there is seen snap ring pliers 20 including section 21 having handle portion 22 and opposed jaw portion 23, and section 25 having handle portion 26 and opposed jaw portion 27. Pivot 28 couples section 21 to section 25 between jaw portions 23 and 27 and handle portions 22 and 26. Jaw portion 23 of section 21 includes inner edge 30, outer edge 31, outer end 32, top side 33, and bottom side 34. Jaw portion 27 of section 25 has inner edge 40, outer edge 41, outer end 42, top side 43, and bottom side 44. Inner edges 30 and 40 axially confront or otherwise face one another. Sections 21 and 25 are substantially coextensive and are preferably made of steel, aluminum, titanium, or other similarly rigid and rugged material or combination of materials, with the exception of the rubber sleeves clothing handle portions 22 and 26 to facilitate gripping by hand. These described rubber sleeves for parts of handle portions 22 and 26.

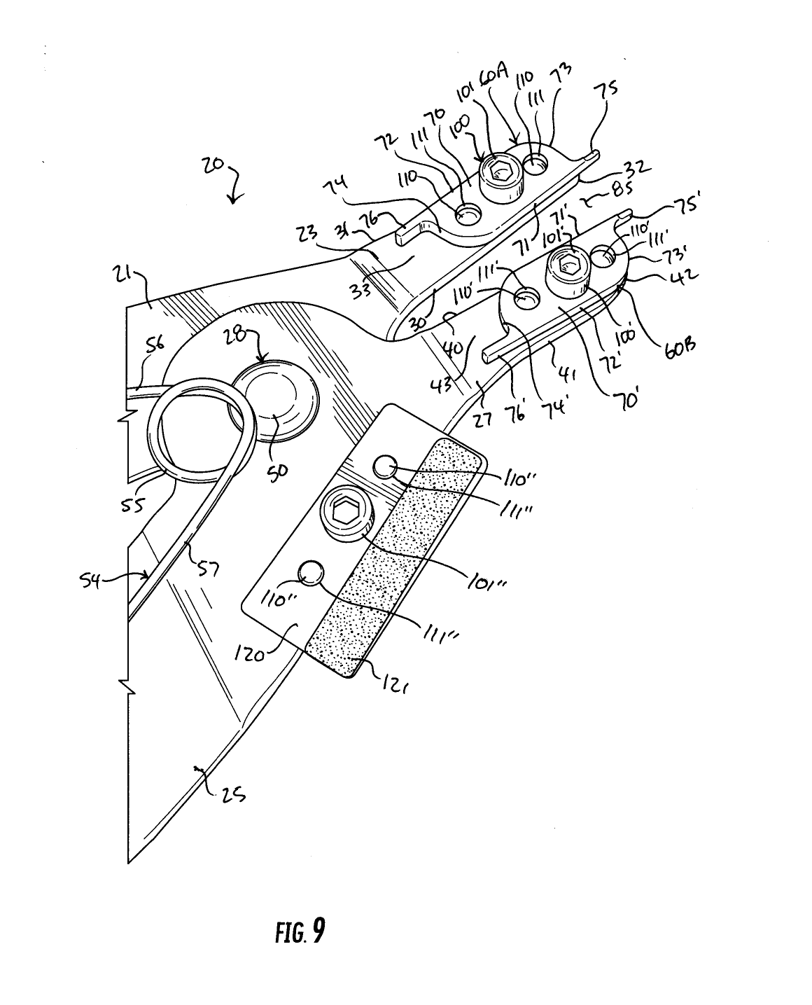

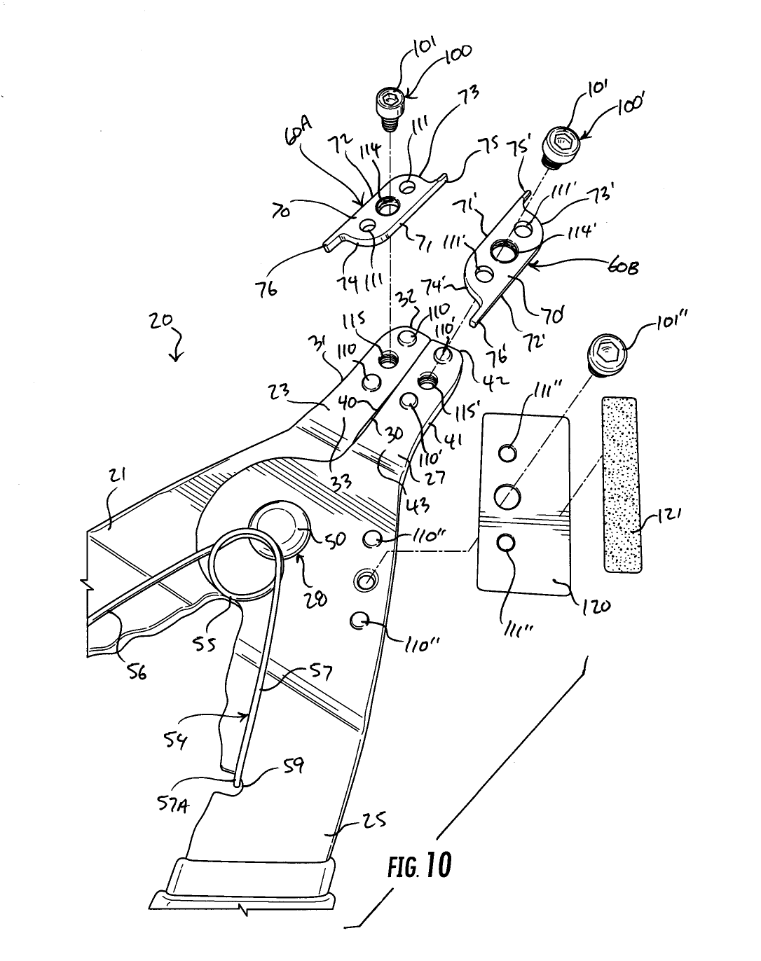

Pivot 28 couples sections 21 and 25 for movement between a first or closed position of sections 21 and 25 illustrated in FIGS. 1-3, 6, 7, and 10-13 corresponding to a closed position of pliers 20, and a second or open position of sections 21 and 25 illustrated in FIGS. 8 and 9 corresponding to an open position of pliers 20. In the first position of sections 21 and 25, jaw portions 23 and 27 are closed or otherwise disposed in a closed position toward one another bringing together inner edges 30 and 40 and handle portions 22 and 26 are open or otherwise disposed in an open position spread apart or away from one another. In the second position of sections 21 and 25, jaw portions 23 and 27 are open or otherwise disposed in an open position away from one another, and handle portions 22 and 26 are closed or otherwise disposed in a closed position toward one another. In the present embodiment as illustrated in FIGS. 1-3, pivot 28 consists of rivet 50 pivotally coupling/joining sections 21 and 25.

A bias is applied to sections 21 and 25 of pliers 20 constantly biasing/urging sections 21 and 25 in the first or closed position in FIGS. 1-3, 6, 7, and 10-13 placing jaw portions 23 and 27 in the closed position thereof and handle portions 22 and 26 in the open position thereof. In FIGS. 1-3, the described bias is applied by spring 54 coupled between sections 21 and 25. Spring 54 constantly acts on sections 21 and 25 constantly biasing sections in the first position. Spring 54 is a tension spring consisting of a wire formed into active coils 55 that leads to tag ends 56 and 57. Spring 54 has two active coils 55, and spring 55 can have less or more active coils in alternate embodiments. Tag end 56 engages section 21, and tag end 57 engages section 25. Tag end 56 is formed with hook 56A received by corresponding notch 58 formed in an inner edge of section 21 between pivot 28 and handle portion 22, and tag end 57 is formed with hook 57A received by corresponding notch 59 formed in an inner edge of section 25 between pivot 28 and handle portion 26.

Spring 54 is fashioned of spring steel, a nickel-based spring alloy, or other material or combination of materials having a substantially constant moduli of elasticity as is typical with tension springs. Spring 54 applies a constant forcible impulse against sections 21 and 25 at hooks 56A and 57A of the respective tag ends 56 and 57 and winds in response to movement of sections 21 and 25 from the first/closed position to the second/open position, and unwinds in response to movement of sections 21 and 25 from the second/open position to the first/closed position. Spring 55 is biased to unwind, thereby biasing sections 21 and 25 in the first/closed position.

Spring 55 coupled to sections 21 and 25 providing the bias as disclosed herein is preferred as it is simple in construction, easy to install, and inexpensive. Although pliers 20 has one spring 55, more can be used, if desired. Those having regard for the art will readily appreciate that any suitable form and number of spring may be coupled to sections 21 and 25 for providing the bias to sections 21 and 25 as disclosed herein without departing from the invention. In the present embodiment, spring 54 provides an outward pushing force against sections 21 and 25 for providing the applied bias. The bias applied to sections 21 and 25 as herein described may be supplied by a spring coupled between sections 21 and 25 that is adapted to apply a pulling force, if desired.

In FIGS. 1-3, and 6-13, pliers 20 includes tipped parts 60A and 60B. Tipped parts 60A and 60B are identical in every respect and are the mirror image opposites of one another. Tipped parts 60A and 60B are made of steel, aluminum, titanium, or other similarly rigid and rugged material or combination of materials.

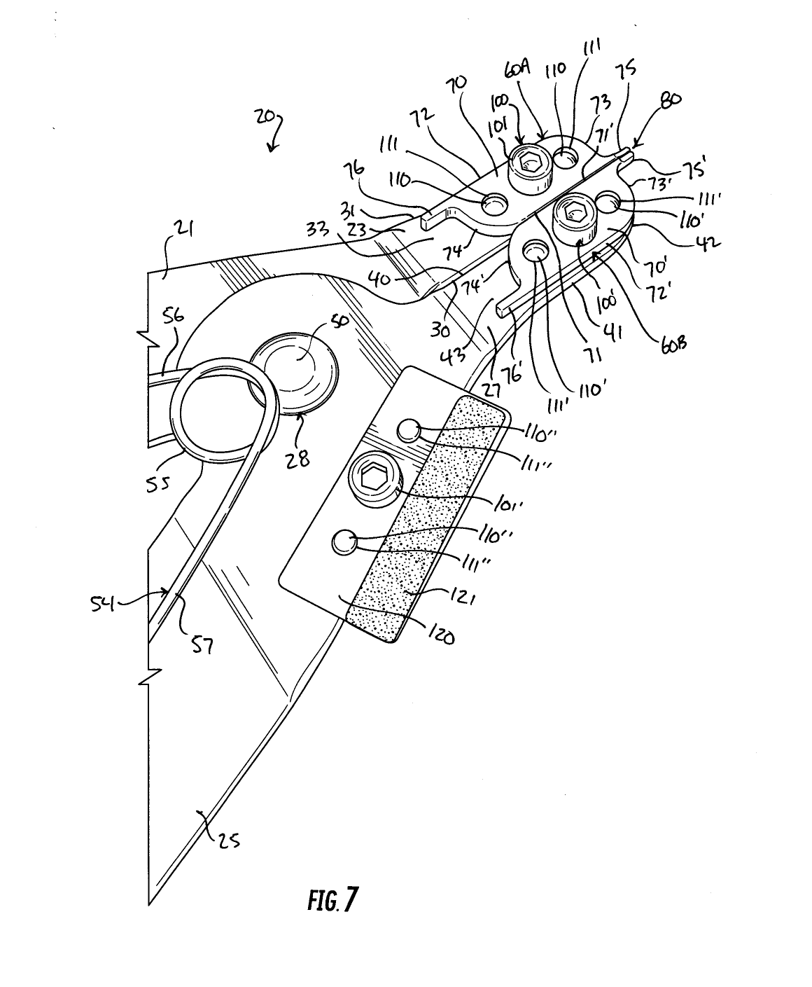

Referencing FIGS. 6-13, tipped part 60A includes body 70 that is flat and that has opposed, parallel edges 71 and 72 that extend between opposed ends 73 and 74, tip 75 formed in end 73, and opposed tip 76 formed in end 74. Tip 75 extends away from end 73, and tip 76 extends away from end 74 in the opposite direction to that of tip 75. In FIGS. 6 and 13, tips 75 and 76 are substantially equal in length, but are different in that tip 75 has width W1 that is less than width W2 of tip 76. Because width W1 of tip 75 is less than width W2 of tip 76, tip 75 is a minor tip 75 and tip 76 is comparatively a major tip 76. Minor tip 75 is located at one side of body 70 at end 73, and edge 71 runs concurrently along body 70 and minor tip 75. Major tip 76 is located at the opposite side of body 70 at end 74, and edge 72 runs concurrently along body 70 and major tip 76.

Tipped part 60B is identical to tipped part 60A and shares the same reference numerals as tipped part 60A, which are each denoted with a prime (“′”) symbol for clarity. And so in common with tipped part 60A, tipped part 60 shares body 70′ that has opposed, parallel edges 71′ and 72′ that extend between opposed ends 73′ and 74′, tip 75′ formed in end 73′, and opposed tip 76′ formed in end 74. Tip 75′ extends away from end 73′, and tip 76′ extends away from end 74′ in the opposite direction to that of tip 75′. In FIGS. 6 and 13, tips 75′ and 76′ are substantially equal in length, but are different in that tip 75′ has width W1′ that is less than width W2′ of tip 76′. Again, because width W1′ of tip 75′ is less than width W2′ of tip 76′, tip 75′ is characterized as a minor tip 75′ and tip 76′ is comparatively characterized as a major tip 76′. Minor tip 75′ is located at one side of body 70′ at end 73′, and edge 71′ runs concurrently along body 70′ and minor tip 75′. Major tip 76′ is located at the opposite side of body 70′ at end 74′, and edge 72′ runs concurrently along body 70′ and major tip 76′.

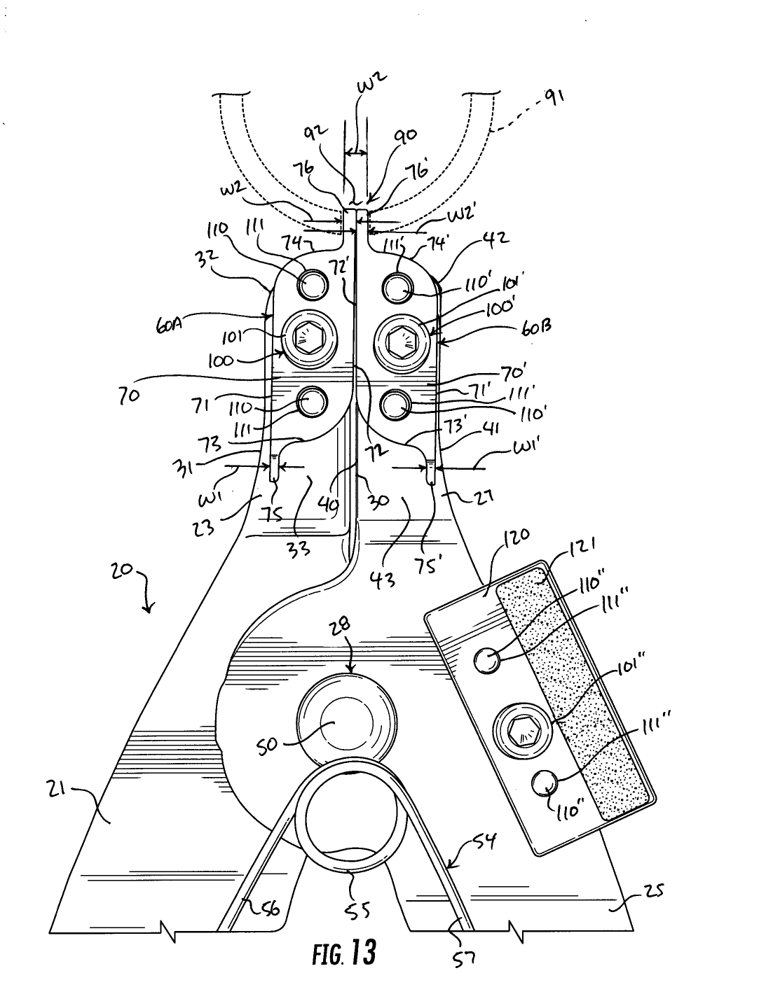

Tipped parts 60A and 60B are removably connectable to the respective jaw portions 23 and 27 so as to be adjustable between first orientations in FIGS. 1-3, 7-9 axially aligning and operatively relating minor tips 75 and 75′ of the respective tipped parts 60A and 60B outwardly from outer ends 32 and 42 of jaw portions 23 and 27, and second orientations in FIGS. 12 and 13 axially aligning and operatively relating major tips 76 and 76′ of the respective tipped parts 60A and 60B outwardly from outer ends 32 and 42 of jaw portions 23 and 27. Of course pivot 28 pivotally couples section 21 to section 25 for movement between the first/closed position of sections 21 and 25 and the second/open position of sections 21 and 25 as previously explained. The first/closed position of sections 21 and 25 is the closed position of jaw portions 23 and 27 and the open position of handle portions 22 and 26, and the second/open position of sections 21 and 25 is the open position of jaw portions 23 and 27 and the closed position of handle portions 22 and 26.

According to the principle of the invention, in the first orientations of tipped parts 60A and 6B pliers 20 is useful in conjunction with a small snap ring having a small snap ring gap, and in the second orientations of tipped parts 60A and 6B pliers 20 is useful in conjunction with a comparatively larger snap ring having a comparatively larger snap ring gap.

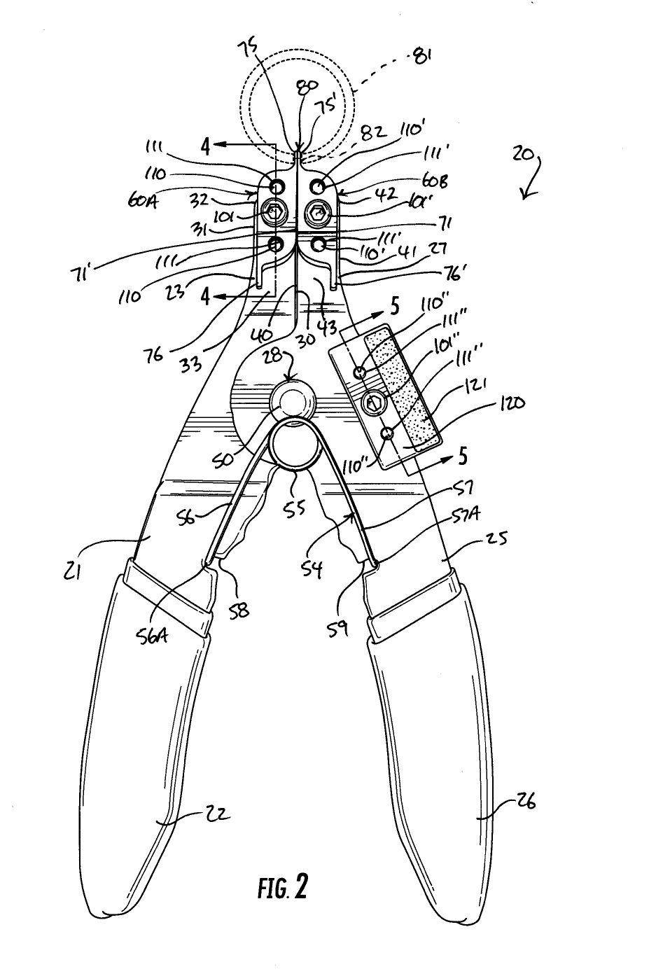

In the first orientations of tipped parts 60A and 60B removably connected to jaw portions 23 and 27 in FIGS. 1-3, 6, and 7, axially aligned edges 71 and 71′ of minor tips 75 and 75′ of bodies 70 and 70′ come into direct contact, and this operative relation between minor tips 75 and 75′ causes minor tips 75 and 75′ to mate, meaning to come into direct contact with one another, forwardly of outer ends 32 and 42 of jaw portions 23 and 27 in the closed position of jaw portions 23 and 27 corresponding to the closed position of sections 21 and 25 of pliers 20 to form a minor tongue 80 by the so mated minor tongues 75 and 75′. Minor tongue 80 has width W3. When minor tips 75 and 75′ are so mated as in FIG. 6, widths W1 and W1′ cooperate to form width W3 of minor tongue 80. Width W3 is the combined widths W1 and W1′ of minor tips 75 and 75′ and is the sum of, and is thus greater than, each of widths W1 and W1′ of minor tips 75 and 75′. Minor tongue 80 is, in accordance with the principle of the invention, adapted to be received in snap ring gap 82 of snap ring 81 denoted in phantom outline in FIGS. 2 and 6. In FIGS. 8 and 9, tipped parts 60A and 60B, including minor tips 75 and 75′, are spaced apart and separated by gap 85 in the open position jaw portions 23 and 27 corresponding to the open position of sections 21 and 25 of pliers 20.

In the use of pliers 20 in the first orientations of tipped parts 60 and 60B in conjunction with snap ring 80 in FIGS. 6 and 8, pliers 20 is taken up and wielded by hand and in the first/closed position of sections 21 and 25 such that jaw portions 23 and 27, and also tipped parts 60A and 60B carried by jaw portions 23 and 27, are in the closed position as illustrated in FIG. 6 and minor tongue 80 is formed by the joining of minor tips 75 and 75′ is inserted in gap 82. When minor tongue 80 formed by mated minor tips 75 and 75′ in the closed position of jaw portions 23 and 27 is inserted in gap 82, minor tip 75 opposes and axially confronts one end of snap ring 81, and minor tip 75′ opposes and axially confronts the other end of snap ring 81. The widths W1 and W1′ of minor tips 75 and 75′ are relatively small and low profile, which ensures that minor tongue 80 formed by joined minor tips 75 and 75′ in the closed position of jaw portions 23 and 27 sufficiently relates to so as to be receivable in gap 82 between the opposed ends of snap ring 81. To open snap ring 81 for installing snap ring onto an anvil of an impact wrench of for removing snap ring 80 from the anvil of an impact wrench, a forcible impulse is applied to handle portions 22 and 26 sufficient to overcome the bias applied by spring 54 moving sections 21 and 25 into the second/open position opening jaw portions 23 and 27 and closing handle portions 22 and 26. As jaw portions 23 and 27 and tipped parts 60A and 60B are driven open from the closed position by squeezing handle portions 22 and 26 together, minor tips 75 and 75′ are, in turn, driven open or apart thereby driving minor tips 75 and 75′ against the respective ends of snap ring 81 apart widening gap 82 sufficiently as illustrated in FIG. 8 to allow snap ring 81 to be passed over an anvil of an impact wrench for installation or removal purposes. When the opposed ends of snap ring 81 are driven part by opening jaw portions 23 and 27 and tipped parts 60A and 60B to widen gap 82, the force applied by minor tips 75 and 75′ against the respective ends of snap ring 81 frictionally engages and secures snap ring 81 retaining snap ring 81 to minor tips 75 and 75′ of tipped parts 60A and 60B of pliers 20, which allows snap ring 81 to then be moved over the anvil of an impact wrench for installation or removal purposes. By maintaining the force against handle portions 22 and 26 of pliers 20 sufficient to maintain jaw portions 23 and 27 open as illustrated in FIG. 8, snap ring 81 will remain frictionally retained to minor tips 75 and 75′. To remove snap ring 81 from minor tips 75 and 75′, snap ring 81 and minor tips 75 and 75′ may simply pulled apart, or the force applied to handle portions 22 and 26 maintaining jaw portions 23 and 27 open may simply be released allowing the bias applied to sections 21 and 25 by spring 54 to bias jaw portions 23 and 27, and thus tipped parts 60A and 60B, closed in FIG. 6 releasing minor tips 75 and 75′ from the respective ends of snap ring 81 allowing snap ring 81 to simply fall away from minor tongue 80 formed by minor tips 75 and 75′.

In the second orientations of tipped parts 60A and 60B turned around 180 degrees from the first orientations and removably connected to jaw portions 23 and 27 in FIGS. 12 and 13, axially aligned edges 72 and 72′ of major tips 76 and 76′ of bodies 70 and 70′ come into direct contact, and this operative relation between major tips 76 and 76′ causes major tips 76 and 76′ to mate, meaning to come into direct contact with one another, forwardly of outer ends 32 and 42 of jaw portions 23 and 27 in the closed position of jaw portions 23 and 27 corresponding to the closed position of sections 21 and 25 of pliers 20 to form a major tongue 90 by the so mated major tongues 76 and 76′. In FIG. 13 major tongue 90 has width W4, which is greater that width W3 of minor tongue 80. When major tips 76 and 76′ are so mated as in FIGS. 12 and 13, in FIG. 13 widths W2 and W2′ cooperate to form width W4 of major tongue 90. Width W4 is the combined widths W2 and W2′ of major tips 76 and 76′, and is the sum of, and thus greater than, each of widths W2 and W2′ of major tips 76 and 76′. Major tongue 90 is, in accordance with the principle of the invention, adapted to be received in snap ring gap 92 of snap ring 91 denoted in phantom outline in FIG. 6. Tipped parts 60A and 60B, including major tips 76 and 76′, are spaced apart and separated by a gap in the open position jaw portions 23 and 27 corresponding to the open position of sections 21 and 25 of pliers 20 as explained above in the first orientation of tipped parts 60A and 60B.

Snap ring 91 is larger than snap ring 81, and gap 92 of snap ring 91 is larger than gap 82 of snap ring 81. In the use of pliers 20 in the second orientations of tipped parts 60 and 60B in conjunction with snap ring 91 in FIG. 13, pliers 20 is taken up and wielded by hand and in the first/closed position of sections 21 and 25 such that jaw portions 23 and 27 are in the closed position and major tongue 90 is formed by the joining of major tips 76 and 76′ is inserted in gap 92. When major tongue 90 formed by mated major tips 76 and 76′ in the closed position of jaw portions 23 and 27 is inserted in gap 92, major tip 76 opposes and axially confronts one end of snap ring 91, and major tip 76′ opposes and axially confronts the other end of snap ring 91. The widths W2 and W2′ of major tips 76 and 76′ are relatively small and low profile albeit greater than widths W1 and W1′ of minor tips 75 and 75′, which ensures that major tongue 90 formed by joined major tips 76 and 76′ in the closed position of jaw portions 23 and 27 sufficiently relates to so as to be receivable in gap 92 between the opposed ends of snap ring 91. To open snap ring 91 for installing snap ring onto an anvil of an impact wrench of for removing snap ring 90 from the anvil of an impact wrench, a forcible impulse is applied to handle portions 22 and 26 sufficient to overcome the bias applied by spring 54 moving sections 21 and 25 into the second/open position opening jaw portions 23 and 27 and closing handle portions 22 and 26. As jaw portions 23 and 27 and tipped parts 60A and 60B are driven open from the closed position by squeezing handle portions 22 and 26 together, major tips 76 and 76′ are, in turn, driven open or apart thereby driving major tips 76 and 76′ against the respective ends of snap ring 91 apart widening gap 92 sufficiently to allow snap ring 91 to be passed over an anvil of an impact wrench for installation or removal purposes. When the opposed ends of snap ring 91 are driven part by opening jaw portions 23 and 27 and tipped parts 60A and 60B to widen gap 92, the force applied by major tips 76 and 76′ against the respective ends of snap ring 91 frictionally engages and secures snap ring 91 retaining snap ring 91 to major tips 76 and 76′ of tipped parts 60A and 60B of pliers 20, which allows snap ring 91 to then be moved over the anvil of an impact wrench for installation or removal purposes. By maintaining the force against handle portions 22 and 26 of pliers 20 sufficient to maintain jaw portions 23 and 27 open, snap ring 91 will remain frictionally retained to major tips 76 and 76′. To remove snap ring 91 from major tips 76 and 76′, snap ring 91 and major tips 76 and 76′ may simply pulled apart, or the force applied to handle portions 22 and 26 maintaining jaw portions 23 and 27 open may simply be released allowing the bias applied to sections 21 and 25 by spring 54 to bias jaw portions 23 and 27, and thus tipped parts 60A and 60B, closed in FIG. 6 releasing major tips 76 and 76′ from the respective ends of snap ring 91 allowing snap ring 91 to simply fall away from major tongue 90 formed by major tips 76 and 76′.

According then to the principle of the invention, in the first orientations of tipped parts 60A and 6B pliers 20 is useful in conjunction with a small snap ring having a small snap ring gap, such as snap ring 81 having snap ring gap 82 discussed above, in the second orientations of tipped parts 60A and 6B pliers 20 is useful in conjunction with a comparatively larger snap ring having a comparatively larger snap ring gap, such as snap ring 91 having snap ring gap 92 discussed above. Depending on the relative size of snap rings to be used in conjunction with pliers 20, widths W1 and W1′ of minor tips 75 and 75′ can be chosen to define width W3 of minor tongue 80, and widths W2 and W2′ of major tongues 76 and 76′ can be chosen to define width W3 of major tongue 90 that is less than width W3 of minor tongue 80.

There are engagement assemblies for removably connecting tipped parts 60A and 60B to the respective jaw portions 23 and 27 in each of the first and second orientations of the respective tipped parts 60A and 60B. One engagement assembly is for removably connecting tipped part 60A to jaw portion 23 in each of the first and second orientations of tipped part 60A, and another engagement assembly is for removably connecting tipped part 60B to jaw portion 27 in each of the first and second orientations of tipped part 60B.

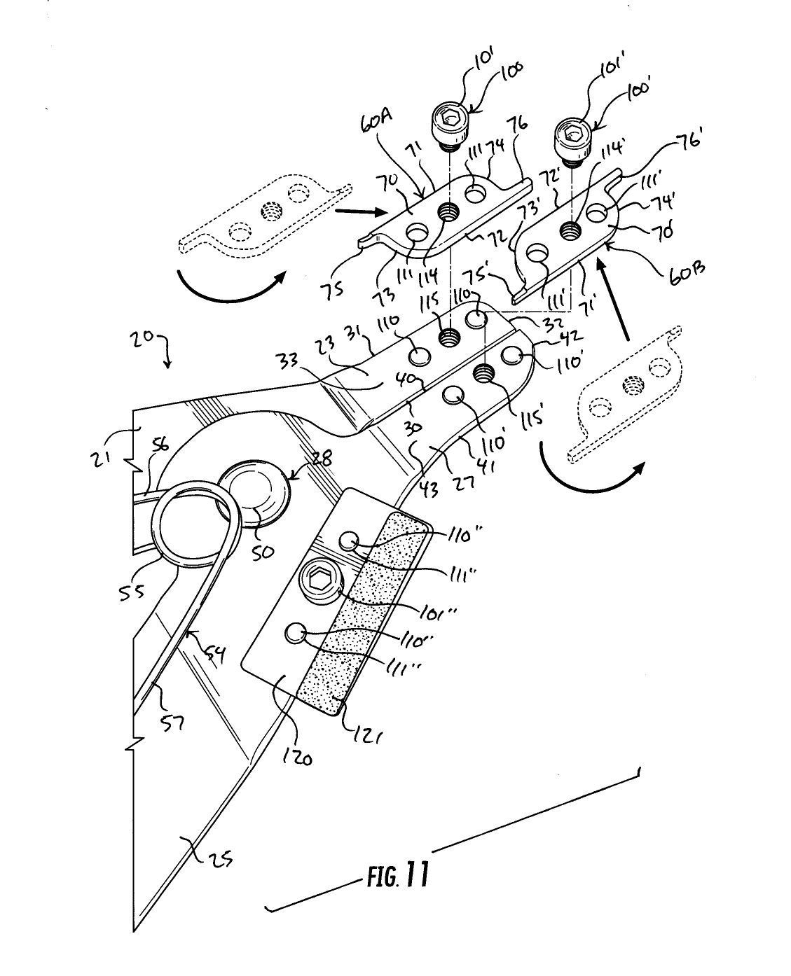

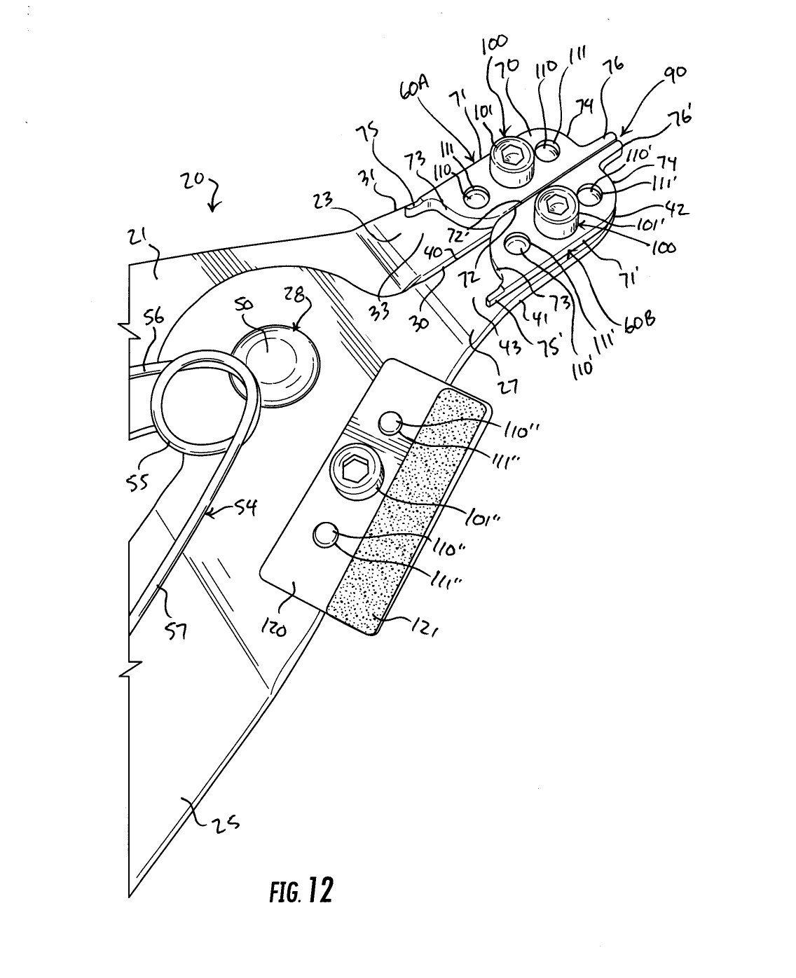

In FIGS. 10 and 11, the engagement assembly for removably connecting tipped part 60A to jaw portion 23 in each of the first and second orientations of tipped part 60A is a detent assembly 100 for alternately keeping tipped part 60A in the first orientation and the second orientation relative to jaw portion 23, and fastener 101 for alternately releasably fastening tipped part 60A to jaw portion 23 in the first orientation and the second orientation of tipped part 60A relative to jaw portion 23. Detent engagement assembly 100 includes detent elements carried by jaw portion 23 adapted to be releasably retained by complementing detent elements carried by tipped part 60A. In this embodiment, the detent elements are male detent elements in the form of protuberances 110, and the complementing detent elements are corresponding female detent elements in the form of openings 111 through body 70 between edges 71 and 72 and ends 73 and 74. Protuberances 110 are axially aligned between inner and outer edges 30 and 31 of jaw portion 23, and protrude upright from top side 33. Protuberances 110 are molded or machined on top side 33. Openings 111 through body 70 of tipped part 60A are axially aligned and relate in size and position to protuberances 110. Threaded opening 114 is formed through jaw portion 23 between protuberances 110, and a corresponding threaded opening 115 is formed through body 70 between openings 111.

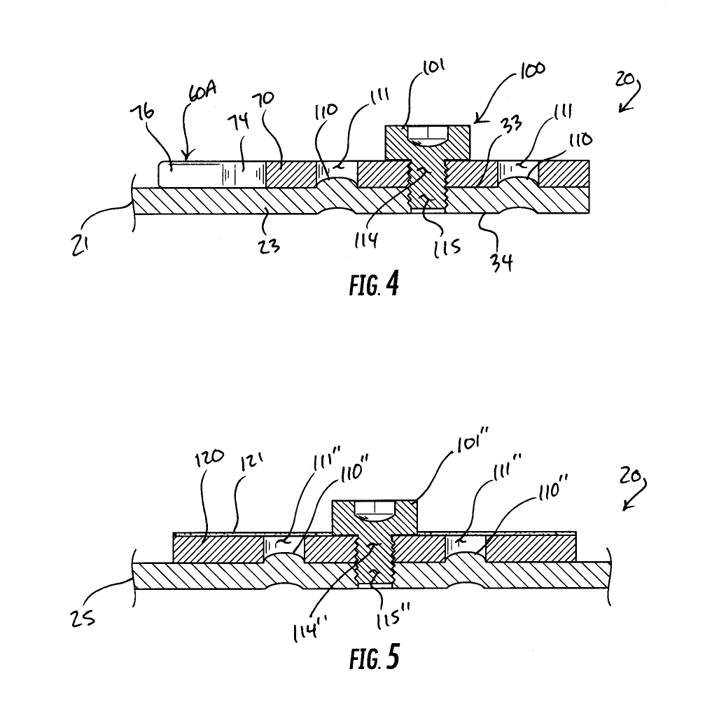

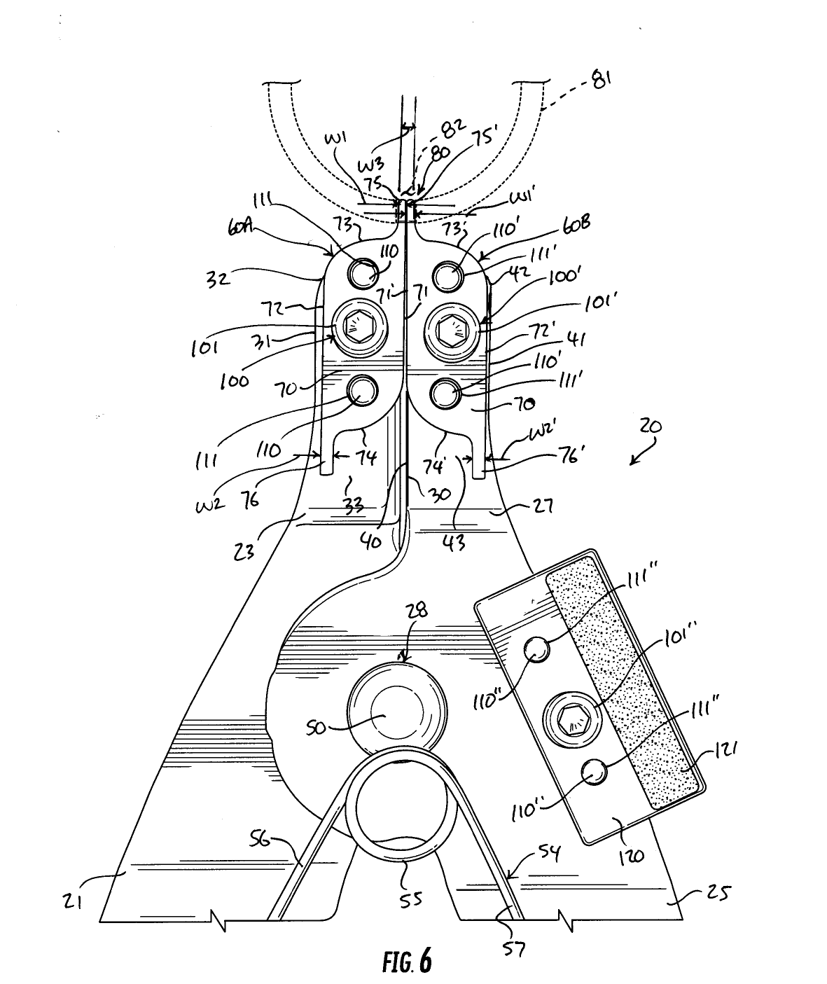

To removably connect tipped part 60A to jaw portion 23 in the first orientation of tipped part 60A, tipped part 60A is oriented into its first orientation as in FIG. 10 aligning openings 111 with protuberances 110 and threaded opening 115 with threaded opening 114. Tipped part 60A is then moved toward top side 33 of jaw portion 23 in the direction of arrowed line A so as to insert protuberances 110 of jaw portion 23 into the corresponding openings 111 of tipped part 60B, which aligns threaded opening 115 of tipped part 60B with threaded opening 114 of jaw portion 23 shown in FIG. 4. This initially and temporarily keeps tipped part 60A on jaw portion 23 in the first orientation of tipped part 60A in preparation for releasably fastening tipped part 60A to jaw portion 23 with fastener 101. Threaded fastener 101 is threaded via rotation through threaded opening 115 of tipped part 60B and is threaded into threaded opening 114 in jaw portion 23 and is tightened via rotation releasably fastening tipped part 60B to jaw portion 23 in the first orientation of tipped part 60B shown in FIGS. 1, 2, and 6-9. To detach tipped part 60A from jaw portion 23, this operation need only be reversed.

To alternately removably connect tipped part 60A to jaw portion 23 in the second orientation of tipped part 60A, tipped part 60A is oriented into its second orientation as in FIG. 11 aligning openings 111 with protuberances 110 and threaded opening 115 with threaded opening 114. Tipped part 60A is then moved toward top side 33 of jaw portion 23, again in the direction of arrowed line A, so as to insert protuberances 110 of jaw portion 23 into the corresponding openings 111 of tipped part 60B, which aligns threaded opening 115 of tipped part 60B with threaded opening 114 of jaw portion 23 as in FIG. 4 previously discussed in the first orientation of tipped part 60A. This initially and temporarily keeps tipped part 60A on jaw portion 23 in the second orientation of tipped part 60A in preparation for releasably fastening tipped part 60A to jaw portion 23 with fastener 101. Threaded fastener 101 is threaded via rotation through threaded opening 115 of tipped part 60B and is threaded into threaded opening 114 in jaw portion 23 and is tightened via rotation releasably fastening tipped part 60B to jaw portion 23 in the second orientation of tipped part 60B in FIGS. 12 and 13. To detach tipped part 60A from jaw portion 23 from the second orientation of tipped part 60A removably connected to jaw portion 23, this operation need only be reversed.

In the present embodiment, protuberances 110 are carried by jaw portion 23 and openings 110 are carried by tipped part 60A. This can be reversed if so desired, and mixed-and-matched if so desired, in which case jaw portion 23 can be fashioned with one protuberance 110 and one opening 111 and tipped part 60A can be fashioned with one protuberance 110 and one opening 111.

The engagement assembly for removably connecting tipped part 60B to jaw portion 27 is identical to the engagement assembly for removably connecting tipped part 60B to jaw portion 27 and shares the same reference numerals as the engagement assembly that removably connects tipped part 60B to jaw portion 27, which are each denoted with a prime (“′”) symbol for clarity. And so in common with the engagement assembly for removably connecting tipped part 60B to jaw portion 27, the engagement assembly for removably connecting tipped part 60B to jaw portion 27 in each of the first and second orientations of tipped part 60B is a detent assembly 100′ in FIGS. 10 and 11 for alternately keeping tipped part 60B in the first orientation and the second orientation relative to jaw portion 27, and fastener 101′ for alternately releasably fastening tipped part 60B to jaw portion 27 in the first orientation and the second orientation of tipped part 60B relative to jaw portion 27. Detent engagement assembly 100′ includes detent elements carried by jaw portion 27 adapted to be releasably retained by complementing detent elements carried by tipped part 60B. In this embodiment, the detent elements are male detent elements in the form of protuberances 110′, and the complementing detent elements are corresponding female detent elements in the form of openings 111′ through body 70′ between edges 71′ and 72′ and ends 73′ and 74′. Protuberances 110′ are axially aligned between inner and outer edges 40 and 41 of jaw portion 27, and protrude upright from top side 43. Protuberances 110′ are molded or machined on top side 43. Openings 111′ through body 70′ of tipped part 60B are axially aligned and relate in size and position to protuberances 110′. Threaded opening 114′ is formed through jaw portion 27 between protuberances 110′, and a corresponding threaded opening 115′ is formed through body 70′ between openings 111.

To removably connect tipped part 60B to jaw portion 27 in the first orientation of tipped part 60B, tipped part 60B is oriented into its first orientation as in FIG. 10 aligning openings 111′ with protuberances 110′ and threaded opening 115′ with threaded opening 114′. Tipped part 60B is then moved toward top side 43 of jaw portion 27 in the direction of arrowed line B so as to insert protuberances 110′ of jaw portion 27 into the corresponding openings 111′ of tipped part 60B, which aligns threaded opening 115′ of tipped part 60B with threaded opening 114′ of jaw portion 27. This initially and temporarily keeps tipped part 60B on jaw portion 27 in the first orientation of tipped part 60B in preparation for releasably fastening tipped part 60B to jaw portion 27 with fastener 101′. Threaded fastener 101′ is threaded via rotation through threaded opening 115′ of tipped part 60B and is threaded into threaded opening 114′ in jaw portion 27 and is tightened via rotation releasably fastening tipped part 60B to jaw portion 27 in the first orientation of tipped part 60B shown in FIGS. 1, 2, and 6-9. To detach tipped part 60B from jaw portion 27, this operation need only be reversed.

To alternately removably connect tipped part 60B to jaw portion 27 in the second orientation of tipped part 60B, tipped part 60B is oriented into its second orientation as in FIG. 11 aligning openings 111′ with protuberances 110′ and threaded opening 115′ with threaded opening 114′. Tipped part 60B is then moved toward top side 43 of jaw portion 27, again in the direction of arrowed line B, so as to insert protuberances 110′ of jaw portion 27 into the corresponding openings 111′ of tipped part 60B, which aligns threaded opening 115′ of tipped part 60B with threaded opening 114′ of jaw portion 27. This initially and temporarily keeps tipped part 60B on jaw portion 27 in the second orientation of tipped part 60B in preparation for releasably fastening tipped part 60B to jaw portion 27 with fastener 101′. Threaded fastener 101′ is threaded via rotation through threaded opening 115′ of tipped part 60B and is threaded into threaded opening 114′ in jaw portion 27 and is tightened via rotation releasably fastening tipped part 60B to jaw portion 27 in the second orientation of tipped part 60B in FIGS. 12 and 13. To detach tipped part 60B from jaw portion 27 from the second orientation of tipped part 60B removably connected to jaw portion 27, this operation need only be reversed.

In the present embodiment, protuberances 110′ are carried by jaw portion 27 and openings 110′ are carried by tipped part 60B. This can be reversed if so desired, and mixed-and-matched if so desired, in which case jaw portion 27 can be fashioned with one protuberance 110′ and one opening 111′ and tipped part 60B can be fashioned with one protuberance 110′ and one opening 111′.

In FIGS. 1, 2, 6-9, and 11-13, pliers 20 is fashioned with file 120. File 120 is removably connected to pliers 20, and is a tool of hardened steel with an abrasive strip 121 for forming or smoothing surfaces especially of metal, such as for cleaning an anvil of an impact wrench. Abrasive strip 121 is affixed to file 120 via adhesive in this embodiment. In an alternate embodiment, an abrasive region may be formed in the material of file 120 via machining or molding. Through the application of a back-and-forth motion applied to pliers 20, an anvil of an impact wrench may be acted upon by file 120 to file away any dirt and debris from the anvil, including the anvil groove into which a snap ring is installed, and for filing away any unwanted burrs and dings and other surface irregularities formed in the anvil, including the anvil groove. File 120 is removably connected to section 25 adjacent to pivot 28 between jaw portion 27 and handle portion 26. File 120 is removably connected to section 25 with an engagement assembly, and projects outboard of, or otherwise outwardly relative to, the outer marginal edge of section 25 away from pivot 28 so as to be available for filing operations discussed briefly above.

The engagement assembly for removably connecting file 120 to section 25 is identical to each of the engagement assemblies used to removably connect tipped parts 60A and 60B to the respective jaw sections 23 and 27 and shares the same reference numerals, which are each denoted with a double prime (“″”) symbol for clarity. And so in common with each of the engagement assemblies for removably connecting tipped parts 60A and 60B to the respective jaw portions 23 and 27, in FIG. 10 the engagement assembly for removably connecting file 120 to section 25 is a detent assembly 100″, and fastener 101″. Detent engagement assembly 100″ includes detent elements carried by section 25 adapted to be releasably retained by complementing detent elements carried by file 120. In this embodiment, the detent elements are male detent elements in the form of protuberances 110″, and the complementing detent elements are corresponding female detent elements in the form of openings 111″ through file 120. Protuberances 110″ are axially aligned, and protrude upright from the top side of section 25. Protuberances 110″ are molded or machined on the top side of section 25. Openings 111″ through of file 120 are axially aligned and relate in size and position to protuberances 110″. Threaded opening 114″ is formed through section 25 between protuberances 110″, and a corresponding threaded opening 115″ is formed through file 120 between openings 111′.

To removably connect file 120 to section 25, file 120 positioned opposite to the top side of section aligning openings 111″ with protuberances 110″ and threaded opening 115″ with threaded opening 114″. File 120 is then moved toward the top side of section 25 in the direction of arrowed line C so as to insert protuberances 110″ of section 25 into the corresponding openings 111″ of file 120, which aligns threaded opening 115″ of file 120 with threaded opening 114″ of section 25. This initially and temporarily keeps file 120 on section 25 in preparation for releasably fastening file 120 to section 25 with fastener 101″. Threaded fastener 101″ is threaded via rotation through threaded opening 115″ of file 120 and is threaded into threaded opening 114″ in section 25 and is tightened via rotation releasably fastening file 120 to section 25 in FIGS. 1, 2, 6-9, and 11-13. To detach file 120 from section 25, this operation need only be reversed.

Those having regard for the relevant art will readily appreciate that an exemplary snap ring pliers 20 is disclosed. Pliers 20 is easy and safe to use, easy to construct, and provides for the efficient and convenient removal and installation of a differently sized snap rings having differently sized snap ring gaps relative to an anvil of an impact wrench. Pliers 20 is inexpensive and no specialized skill is required to use pliers 20 and hastens and simplifies the normally tedious and time-consuming process of removing and installing snap rings, particularly snap rings of varying size having differently sized snap ring gaps.

The invention has been described above with reference to preferred embodiments. However, those skilled in the art will recognize that changes and modifications may be made to the embodiments without departing from the nature and scope of the invention. Various changes and modifications to the embodiments herein chosen for purposes of illustration will readily occur to those skilled in the art. To the extent that such modifications and variations do not depart from the spirit of the invention, they are intended to be included within the scope thereof.

Having fully described the invention in such clear and concise terms as to enable those skilled in the art to understand and practice the same, the invention claimed is:

1. Snap ring pliers, comprising:
a first section includes a first handle portion and an opposed first jaw portion;
a second section includes a second handle portion and an opposed second jaw portion;
a first tipped part includes a first minor tip and an opposed first major tip;
a second tipped part includes a second minor tip and an opposed second major tip;
the first and second tipped parts are removably connectable to the respective first and second jaw portions in first orientations operatively relating the first and second minor tips of the first and second tipped parts outwardly from the first and second jaw portions, and second orientations operatively relating the first and second major tips of the first and second tipped parts outwardly from the first and second jaw portions;
a pivot pivotally couples the first section to the second section for movement between a first position of the first and second sections and a second position of the first and second sections;
the first position of the first and second sections is a closed position of the first and second jaw portions and an open position of the first and second handle portions;
the second position of the first and second sections is an open position of the first and second jaw portions and a closed position of the first and second handle portions;
in the first orientations of the first and second tipped parts the first and second minor tips mate in the closed position of the first and second jaw portions to form a minor tongue adapted to be received in a snap ring gap, and the first and second minor tips are spaced apart and separated by a gap in the open position of the first and second jaw portions;
in the second orientations of the first and second tipped parts the first and second major tips mate in the closed position of the first and second jaw portions to form a major tongue adapted to be received in a snap ring gap, and the first and second major tips are spaced apart and separated by a gap in the open position of the first and second jaw portions;
the minor tongue is smaller than the major tongue; and
a bias acting on the first and second sections biasing the first and second sections in the first position.

2. The snap ring pliers according to claim 1, wherein the bias is supplied by a spring coupled between the first and second sections.

3. The snap ring pliers according to claim 1, further comprising a first engagement assembly for removably connecting the first tipped part to the first jaw portion in each of the first and second orientations of the first tipped part, and a second engagement assembly for detachably connecting the second tipped part to the second jaw portion in each of the first and second orientations of the second tipped part.

4. The snap ring pliers according to claim 3, wherein the first engagement assembly comprises:
a first detent assembly for alternately keeping the first tipped part in the first orientation and the second orientation relative to the first jaw portion; and
a first fastener for alternately releasably fastening the first tipped part to the first jaw portion in the first orientation and the second orientation of the first tipped part relative to the first jaw portion.

5. The snap ring pliers according to claim 4, wherein the first detent assembly comprises first detent elements carried by the first jaw portion and first complementing detent elements carried by the first tipped part.

6. The snap ring pliers according to claim 5, wherein each of the first detent elements is one of a first male detent element and a first female detent element, and each of the first complementing detent elements is the other of the first male detent element and the first female detent element.

7. The snap ring pliers according to claim 6, wherein the first fastener comprises a first threaded fastener.

8. The snap ring pliers according to claim 7, wherein the second engagement assembly comprises:
a second detent assembly for alternately keeping the second tipped part in the first orientation and the second orientation relative to the second jaw portion; and
a second fastener for alternately releasably fastening the second tipped part to the second jaw portion in the first orientation and the second orientation of the second tipped part relative to the second jaw portion.

9. The snap ring pliers according to claim 8, wherein the second detent assembly comprises second detent elements carried by the second jaw portion and second complementing detent elements carried by the second tipped part.

10. The snap ring pliers according to claim 9, wherein each of the second detent elements is one of a second male detent element and a second female detent element, and each of the second complementing detent elements is the other of the second male detent element and the second female detent element.

11. The snap ring pliers according to claim 10, wherein the second fastener comprises a second threaded fastener.

12. The snap ring pliers according to claim 11, further comprising a file removably connected to the second section between the second handle portion and the second jaw portion, the file projecting outboard of the second section.

13. The snap ring pliers according to claim 1, further comprising a third engagement assembly removably connecting the file to the second section.

14. The snap ring pliers according to claim 13, wherein the third engagement assembly comprises:
a third detent assembly temporarily keeping the file in position on the second section; and
a third fastener releasably fastening the file to the second section.

15. The snap ring pliers according to claim 4, wherein the third detent assembly comprises third detent elements carried by the second section and third complementing detent elements carried by the file.

16. The snap ring pliers according to claim 15, wherein each of the third detent elements is one of a third male detent element and a third female detent element, and each of the third complementing detent elements is the other of the third male detent element and the third female detent element.

17. The snap ring pliers according to claim 16, wherein the third fastener comprises a third threaded fastener.

18. The snap ring pliers according to claim 1, wherein the first tipped part and the second tipped part are identical.

19. The snap ring pliers according to claim 3, wherein the first engagement assembly and the second engagement assembly are identical.
